(19) United States
(12) Patent Application Publication
(10) Pub. No.: US 2024/0270215 A1
(43) Pub. Date: Aug. 15, 2024

(54) ELECTRIC OVER HYDRAULIC BRAKING SYSTEM

(71) Applicant: Dale James HYND, Ravenswood (AU)

(72) Inventor: Dale James HYND, Ravenswood (AU)

(21) Appl. No.: 18/437,752

(22) Filed: Feb. 9, 2024

(30) Foreign Application Priority Data
Feb. 9, 2023 (AU) 2023900319

(51) Int. Cl. B60T 7/20; B60T 13/14; B60T 13/58; B60T 13/68; B60T 13/74; B60T 17/22

(52) U.S. Cl. CPC B60T 7/20; B60T 13/148; B60T 13/586; B60T 13/686; B60T 13/745; B60T 17/22; B60T 17/225; B60T 2270/402; B60T 2270/414

(57) ABSTRACT

An electric over hydraulic (EOH) braking system incorporates (1) a battery-powered backup breakaway unit internally with (2) an EOH brake actuator unit and (3) brake actuation control unit, in a single enclosed housing. The braking system also includes wireless communication devices for connecting with a smart device (e.g. smartphone, tablet, laptop) running an application software for controlling various operating functions and options of the braking system. The braking system also includes sensors, and monitoring of the braking system component conditions for maintenance and proper operation.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to an electric over hydraulic braking system for trailer, caravans and RVs.

### 2. Description of Related Art Including Information Disclosed Under 37 CFR 1.97 and 37 CFR 1.98

Electric over hydraulic (EOH) brakes for trailers/caravans use similar hydraulic brake lines as for the tow vehicle. EOH brakes use a motor on the brake actuator powered by electricity from the tow vehicle. This produces the necessary hydraulic pressure to activate the trailer brakes.

A breakaway system is required, by law, to power the brake actuator unit in the event of the trailer or caravan breaking away from the tow vehicle. The current breakaway systems include a breakaway switch which is mounted to the trailer, and a backup battery also mounted to the trailer. The breakaway switch has a pull pin connected by cable to the tow vehicle. In the event of tow vehicle separation from the trailer/caravan, the pull pin is removed by the cable attached to the tow vehicle, which triggers the breakaway switch to direct battery power to the trailer brakes. This leads to locking of the trailer brakes to bring the trailer or caravan to a safe stop.

The current systems have a number of disadvantages. They are hard to install as they require proper wiring to work and be reliable. The breakaway system is not waterproof and can corrode or stop working. The battery is typically housed in a separate box where the battery charge can be left unmonitored or in unknown charge condition.

An In-Cab controller is also required in order to activate the EOH braking unit fitted to the trailer. This means that a brake controller, compatible with EOH trailer brakes, is required in the towing vehicle. The trailer brake controller allows the adjustment of the braking pressure (gain—from a minimum to maximum) and also the manual emergency activation of braking to the trailer independently of the tow vehicle. The In-Cab controller systems are fitted and wired to the tow vehicle, which can be factory-installed (integrated) into the tow vehicle or retro fitted. As such, the trailer can only be towed by a vehicle fitted with a compatible in-cab controller.

The present invention seeks to overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### BRIEF SUMMARY OF THE INVENTION

According to a first aspect, the present invention an electric over hydraulic (EOH) brake system for mounting to a trailer, the system comprising:
a housing which contains within its internal space:
a brake actuator unit to be fluidly connected to the hydraulic brakes of a trailer,
a brake actuation control unit, and
a battery-powered backup breakaway unit,
which are disposed and enclosed within the housing.

Preferably, the brake system further includes wireless communication means for connecting with a smart device running an application software for controlling various operating functions of the braking system.

Preferably, the brake system further includes sensors for monitoring braking system component conditions for maintenance and proper operation.

Preferably, the brake system further includes the brake actuator unit includes a motor with a PCB driver, a solenoid valve, and a fluid tank, wherein in use the motor drives the solenoid valve for pushing fluid from the tank under pressure to the hydraulic brakes.

Preferably, the brake actuation control unit includes a controller PCB connected to a wireless communication means.

Preferably, the battery-powered backup breakaway unit includes a battery and a breakaway system, wherein the battery provides backup power to the motor if the breakaway system is activated.

Preferably, the sensors includes one or more of a GPS receiver, temperature sensor, moisture sensor, fluid sensor, and/or pressure sensor all electronically connected to the controller PCB.

Preferably, the brake system further includes additional sensors for mounting to the trailer including vibration/heat sensors adjacent the trailer wheels, force sensors and/or a camera, being electronically connected to the controller PCB.

Preferably, the brake system further includes a smart device application software having one or more of the following functions:
setting pulse width modulation,
controller gain for control over braking,
status updates for service brakes,
independent braking control,
moisture alarm,
temperature alarm,
fluid level alarm,
fluid pressure alarm,
visual trailer monitoring being the output from the camera,
a trailer sway alarm,
breakaway battery health monitoring, and
a voice activation button on the user smart device to the integrated management system.

Preferably, power to the sensors is provided by energy harvesting such as solar panels or a regenerative braking system.

The invention also provides a trailer having the EOH system unit of any one of the above installed to the tow bar of the trailer.

Other aspects of the invention are also disclosed.

### BRIEF DESCRIPTION OF THE SEVERAL VIEWS OF THE DRAWINGS

Notwithstanding any other forms which may fall within the scope of the present invention, preferred embodiments of the present invention will now be described, by way of examples only, with reference to the accompanying drawings.

FIG. 1 shows an exploded perspective view of an EOH braking system in accordance with a preferred embodiment of the present invention.

FIG. 2 shows a perspective view of a trailer with sensors of the braking system.

FIGS. 3 to 8 show screenshot illustrations of interfaces of example screenshots of the mobile App interface software.

FIG. 9 shows a schematic view of a trailer with the present braking system mounted, and a tow vehicle with a smart device running the application software.

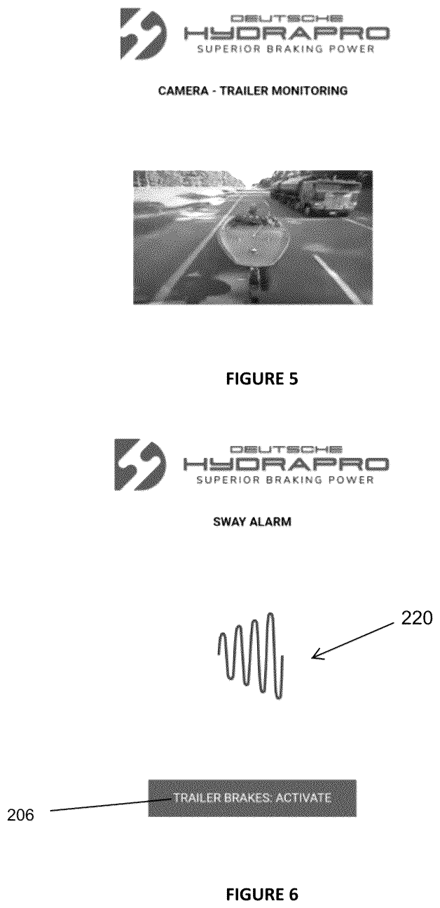

FIG. 10 shows an exploded perspective view of an EOH braking system similar to FIG. 1.

FIG. 11 shows an exploded perspective view of highlights of the housing and the EOH brake actuator unit.

FIG. 12 shows an exploded perspective view of highlights of the control unit and the breakaway unit.

FIG. 13 shows an exploded perspective view of highlights of the sensors.

### DETAILED DESCRIPTION OF THE INVENTION

It should be noted in the following description that like or the same reference numerals in different embodiments denote the same or similar features.

### Integrated Management System

The present braking system 100 incorporates (1) the battery-powered backup breakaway unit 32 internally with (2) the EOH brake actuator unit 34 and (3) brake actuation control unit 33, in a single enclosed housing 17. The present braking system 100 also includes wireless communication means 36 for connecting with a smart device (e.g. smartphone, tablet, laptop) running an application software (app) for controlling various operating function and options of the braking system 100. The present braking system 100 also includes sensors 38, and monitoring of the braking system component conditions for maintenance and proper operation. This allows the EOH braking system 100 to be more easily fitted to the trailer without having to mount and wire in a separate battery backup breakaway system and also provides additional features.

In the present EOH braking system 100, by combining and connecting all three functions: the brake actuator unit 34, breakaway unit 32, and brake actuation control unit 33, the new product is able to provide central management of the braking system, which can be directly monitored and remotely controlled.

The present system incorporates the electronic braking actuation control unit 33 (similar to the traditional In-Cab controller system) into the enclosed housing together with the EOH brake actuator unit and backup breakaway unit. This allows a trailer or caravan with the braking system 100 to be towed by any vehicle without the vehicle having to be fitted with a compatible In-Cab controller.

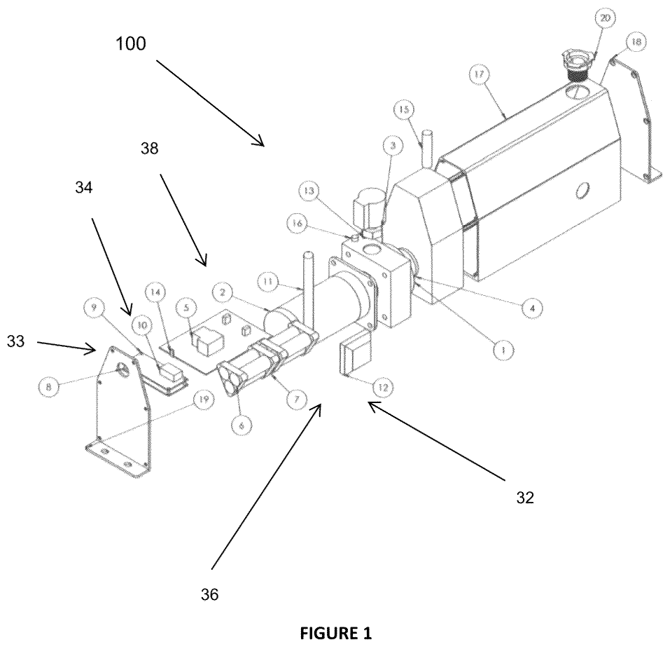

FIG. 1 shows an EOH braking system 100 having a housing 17 which contains within its internal space: a motor 2, block 1, solenoid valve 3, fluid tank 4, PCB (printed circuit board) driver 5, batteries 6 held by holders 7, controller PCB 8, spacer 9, breakaway system 10, Bluetooth receiver 11, GPS transceiver 12, temperature sensor 13, moisture sensor 14, fluid sensor 15, and pressure sensor 16. Open ends of the housing 17 are closed by end plates 18 and 19, and a lid mount 20 closes an upper opening of the housing 17 which leads to the fluid tank 4.

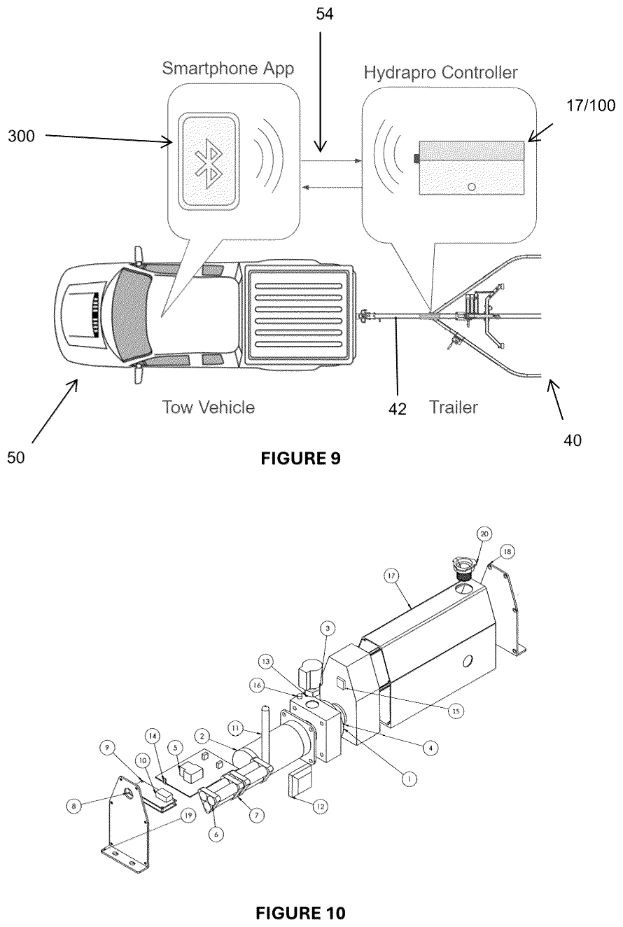

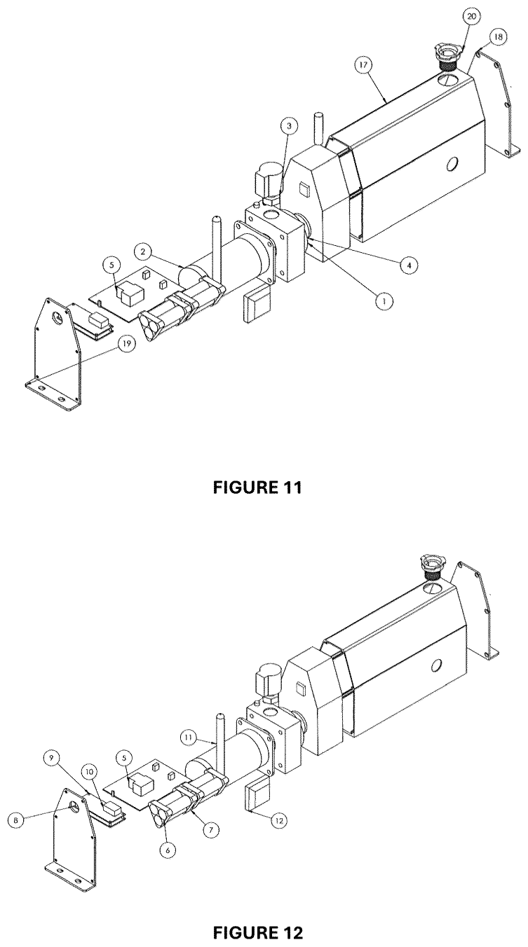

As also shown in FIG. 11, the motor 2 drives the solenoid valve 3 for pushing fluid from the tank 4 under pressure to the hydraulic brakes (the break actuator unit 34). As also shown in FIG. 12, the battery 6 provides backup power to the motor 2 if the breakaway system 10 is activated (the breakaway unit 32). Operation of the motor 2 is controlled by the PCB driver 5, which receives signal from a controller PCB 8 (braking control unit 33).

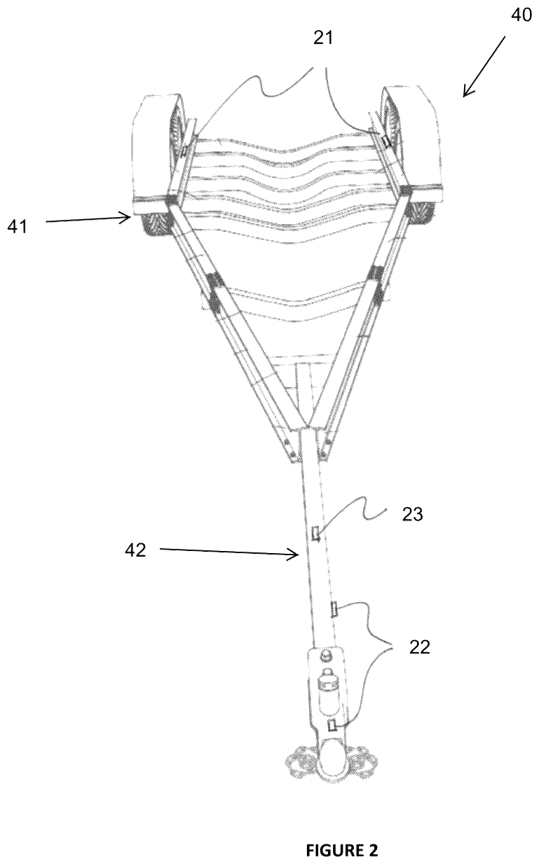

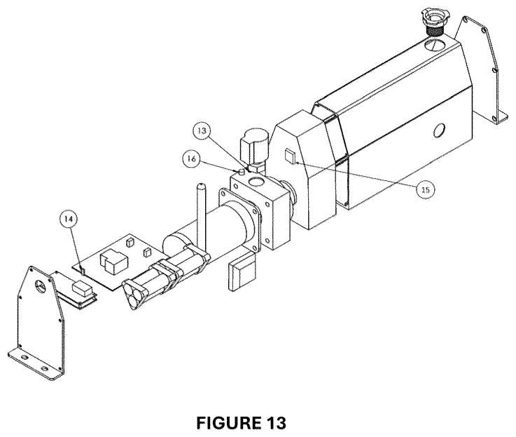

The controller PCB 8 is electronically connected to the Bluetooth receiver 11, GPS receiver 12 (together forming the wireless communication means 36), temperature sensor 13, moisture sensor 14, fluid sensor 15, and pressure sensor 16 (part of the sensors 38 as also shown in FIG. 13). As shown in FIG. 2, additional sensors 38 are provided to the trailer 40 including vibration/heat sensors 21 at the wheels 41, and force sensors 22 and a camera 23 at the tow bar 42. These sensors 21 to 23 are also electronically connected to the controller PCB 8.

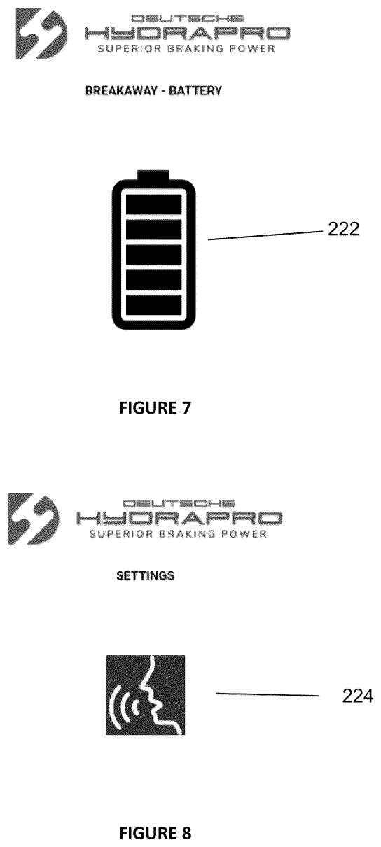

The housing 17 with the internal components described above are installed in use to the tow bar 42 of the trailer 40 or to some other suitable position thereon. As shown for example in FIG. 10, the housing 17 with the brake system 100 is mounted to a forward portion 42 of the trailer 40, such that a cable for the breakaway unit 32 can reach the tow vehicle 50. Alternatively, a separate pull switch can be connected to the brake system 100. The EOH braking system 100 is then fluidly connected to the hydraulic brakes of the trailer 40.

The traditional In-Cab controller is replaced by a smartphone or smart device running the EOH system Mobile App (smartphone software application) 300 as described below. The smart device is mounted via a cradle or other suitable removable mount inside the cabin of the tow vehicle 50. As shown, there is a wireless connection 54 between the brake system 100 and the smart device running the app 300.

The smart phone or device interface to the management system hardware 100 is via suitable wireless communication system, such as Bluetooth technology, Wi-Fi, or similar. To power the sensors 21 to 23 on the trailer, energy harvesting is preferably utilized, for example via solar panels or a regenerative braking system.

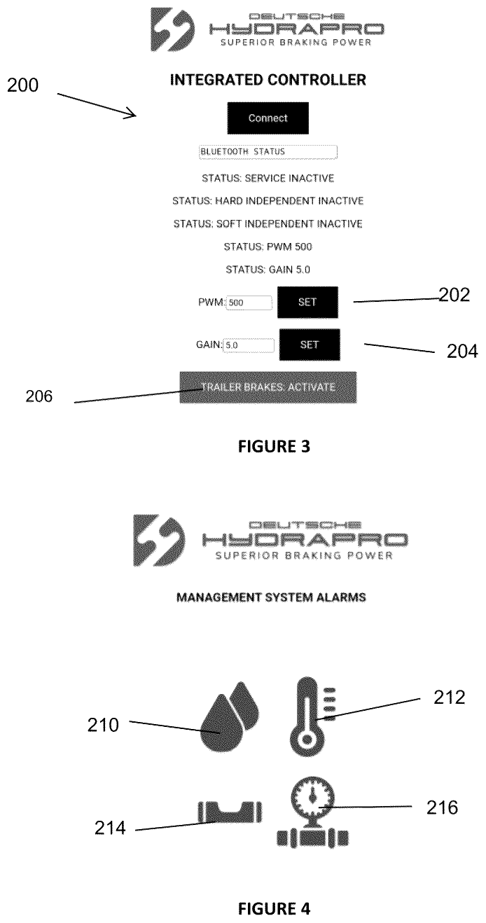

FIGS. 3 to 8 show interfaces or example screenshots of the mobile App 300 interface software.

FIG. 3 shows an integrated controller mobile phone/device app application interface 200. This interface 200 enables the user to set pulse width modulation 202 and controller gain 204 for control over braking force level applied to the trailer brakes. This interface also give status updates for service brakes and independent manual activated braking 206, for emergency braking for example. This provides the functionality of integrated or retro fitted wired traditional In-Cab controller systems.

FIG. 4 shows another interface screen with the management system alarms, including moisture alarm 210, temperature alarm 212, fluid level alarm 214, fluid pressure alarm 216. Colour RED shows alarm is active, BLACK indicates normal operation. This provides the functionality of monitoring various conditions within the brake system 100 which were not previously available in traditional systems.

FIG. 5 shows another interface screen with visual trailer monitoring being the output from the camera 23. This provides the functionality of visual monitoring of the trailer which is not previously available in traditional systems.

FIG. 6 shows another interface screen with a trailer sway alarm 220 with user brake activation 206 via smart phone application or In-Cab RF remote control.

FIG. 7 shows another interface screen with breakaway battery health monitoring 222. This provides immediate battery charge and health monitoring which is not available in traditional systems. Traditional systems do not provide a measure of battery charge or health which can lead to no activation of the breakaway system when needed,

FIG. 8 shows another interface screen with voice activation button 224 on the user smart device to the integrated management system.

The invention, having incorporated all three systems (brake actuator unit, battery-powered backup breakaway unit, brake actuation controller unit), together with additional features such as wireless communication and remote sensors and management system, into the one unit 100 will be able to centrally manage and monitor the combined system. The new fully integrated EOH braking system will be able to remotely monitor battery power and charge levels.

The present EOH brake system will also incorporate other sensors that will allow the complete remote management, via a Mobile App (smartphone software application), not only of the braking system, but the trailer itself. Electronic sensors within the unit will detect vibration via sensor 21, tow force via sensor 22, temperature (item 13), moisture (item 14), and brake fluid level/pressure (item 15 and 16). These sensors will provide immediate information to the user as well as providing alerts when any of the measurements are outside desired ranges.

A GPS transceiver 12 will be incorporated to help determine trailer mileage for maintenance purposes, and will also provide assistance in the event of theft recovery. Moreover, a camera 23 will also be incorporated into the EOH brake system 100 which will allow real time visual monitoring and inspection of the trailer whilst under tow.

Currently there is no EOH brake system for trailers that has a complete braking operation, management and monitoring as described. This new EOH braking system product will provide an important technological advance in trailer braking system management and road safety.

The new EOH brake unit will allow the tow vehicle driver to remotely monitor or to be notified in real time (via Mobile App, voice message, alarm or email) of any braking system or trailer issues. These issues would include things such as low brake fluid levels or leaks, failing wheel bearings, overheating of the braking system, or when the trailer and or brake system requires maintenance. This real time monitoring capability will reduce trailer breakdowns and accidents on the roads.

By combining and connecting all three systems: the actuator unit, breakaway unit, and brake actuation control unit, with wireless communication means to a smart device app, the product is able to provide central management of the braking system, which can be directly monitored and controlled remotely via a wirelessly connected smart device. This complete brake and trailer management system will provide unprecedented technological advancement in the trailer braking systems, monitoring, and management.

Moreover, this fully integrated EOH braking and management system can be incorporated into all types of trailers, travel trailers, RV's, gooseneck trailers and also has applications with remote control and electric vehicles, robot drones, and other military vehicles.

The system also allows the trailer 40 to be towed by any vehicle as long as the user has the mobile control app 300 paired with the EOH system 100. A vehicle with an in-cab controller is no longer needed.

### Unique Functions and Capabilities

1. The brake system incorporates the battery-powered backup breakaway system internally to the EOH brake actuator unit. The invention provides an electric over hydraulic brake system which is integrated into a single sealed housing unit. This allows the EOH braking system to be more easily fitted to the trailer without having to mount and wire in a separate battery backup breakaway system. This reduces possible errors in installation, possible damage to components as the housing protects the components, and provides for easier maintenance and reliability.

2. The brake system incorporates a controller unit (similar to the traditional In-Cab controller system) into the EOH brake actuator unit. This allows the braking system to be towed by any vehicle without the vehicle having to be fitted with a compatible In-Cab controller.

3. The brake system having incorporated all three systems into one single unit will be able to centrally manage and monitor the combined system. The new fully integrated EOH braking system will be able to remotely monitor battery power and charge levels.

4. The new EOH brake system will also incorporate other sensors that will allow the complete remote management, via a Mobile/smart device App, not only of the braking system, but the trailer itself. Electronic sensors within the unit will detect vibration, temperature, moisture, and brake fluid level. A GPS will be incorporated to help determine trailer mileage for maintenance purposes, and will also provide assistance with theft recovery. Moreover, a camera will also be incorporated into the EOH brake system which will allow real time visual monitoring and inspection of the trailer whilst under tow.

The trailer brake system represents a complete trailer management system with incorporation of electronic sensors that provide data on temperature, moisture, fluid level, and vibration. This allows the remote detection via mobile/smartphone app of braking and trailer issues before they become a problem or cause failures. The system provides an EOH brake actuator plus a complete trailer management system via App/integrated controller/built in breakaway system.

The Electric Over Hydraulic Brake Actuator system includes a number of new features that centralises the control and safety functions required on EOH braking systems and allows control and monitoring of the braking system remotely and directly to the tow vehicle driver.

a. Internal Controller: The electronic braking pressure control system is directly connected to the trailer's EOH brake actuator system. This removes the need of a brake control unit fitted to the tow vehicle. The brake controller paired with the smart device app allows the user or driver to adjust the braking force for the trailer brakes and to apply the trailer brakes independently. The electronic controller is connected to the motor and valve that drives the hydraulic pump and governs the maximum pressure or flow rate of the pump which translates to the braking force able to be applied under full braking conditions.

b. Battery Backup: The breakaway battery system that is required on EOH braking systems is fitted internally with the brake actuator and no longer requires an external component to be connected to the brake system. The battery system is monitored, and charge status managed so the battery remains charged. There is a trickle charge and fast charge option which can be controlled by the user and driver.

c. Monitoring of System and trailer: There are specific sensors fitted to the EOH brake system measuring fluid level, moisture, heat, current and pressure, as well as GPS and video data that can provide location, distance, and visual information to the driver for maintenance and system warning information. A sonic sensor is connected to the fluid tank, humidity sensor on the bottom of the housing, amperage use is measured and also used to calculate fluid flow and pressure information. A temperature sensor connected to the hydraulic block. A GPS tracker and video camera and fitted into the EOH system. All this combined data from the controller, battery backup, and sensor components are transmitted wirelessly such as via Bluetooth to the smartphone App. This enables the user or driver to be able to remotely operate, monitor and manage the braking system and receive information of potential issues with the braking system before a fault occurs. This can be used to avoid loss of brakes before getting the necessary maintenance required.

By combining all these components and systems including the sensors into one central brake actuator system, there is provides a complete brake and trailer management system that is controlled remotely by smart app or remote control device. This allows any tow vehicle to be able to tow any trailer fitted with this brake actuator system. It allows trailers to be used, controlled and monitored easily without having to install external systems (brake controller and breakaway systems) to all the potential different tow vehicles. This is also especially useful for trailer fleets and hire trailers that are used by multiple tow vehicles so they can be used, monitored, and maintained more easily. It will provide a level of safety and protection of the braking system, which has not been available before. Operational status and functionality including the level of braking force can be monitored, managed, and adjusted by the user or driver. The smart phone app can also be monitored and controlled via the tow vehicles touch screen with apple car play or android auto connection systems. This allows the driver to use voice activation and touch screen to control the braking system as well as receive visual alerts on system functionality.

1. An electric over hydraulic (EOH) brake system for mounting to a trailer, the system comprising:
a housing having an internal space:
a brake actuator unit disposed and enclosed within the housing to be fluidly connected to the hydraulic brakes of a trailer,
a brake actuation control unit disposed and enclosed within the housing, and
a battery-powered backup breakaway unit disposed and enclosed within the housing.

2. The brake system of claim 1, further comprising: wireless communication means for connecting with a smart device running an application software for controlling various operating functions of the braking system.

3. The brake system of claim 1, further comprising: sensors for monitoring braking system component conditions for maintenance and proper operation.

4. The brake system of claim 1, wherein the brake actuator unit is comprised of a motor with a PCB driver, a solenoid valve, and a fluid tank, and wherein in use the motor drives the solenoid valve for pushing fluid from the tank under pressure to the hydraulic brakes.

5. The brake system of claim 4, wherein the brake actuation control unit is comprised of a controller PCB connected to a wireless communication means.

6. The brake system of claim 1, wherein the battery-powered backup breakaway unit is comprised of a battery and a breakaway system, and wherein the battery provides backup power to the motor if the breakaway system is activated.

7. The brake system of claim 5, wherein the sensors comprises one or more of a GPS receiver, temperature sensor, moisture sensor, fluid sensor, and/or pressure sensor all electronically connected to the controller PCB.

8. The brake system of claim 7, further comprising additional sensors for mounting to the trailer, the additional sensors being comprised of vibration/heat sensors adjacent the trailer wheels, force sensors and/or a camera, being electronically connected to the controller PCB.

9. The brake system of claim 2, further comprising: a smart device application software having one or more of the following functions:
setting pulse width modulation,
controller gain for control over braking,
status updates for service brakes,
independent braking control,
moisture alarm,
temperature alarm,
fluid level alarm,
fluid pressure alarm,
visual trailer monitoring being the output from the camera,
a trailer sway alarm,
breakaway battery health monitoring, and
a voice activation button on the user smart device to the integrated management system.

10. The braking system of claim 7, wherein power to the sensors is provided by energy harvesting such as solar panels or a regenerative braking system.

11. A trailer, comprising: the EOH brake system unit of claim 1 installed to the tow bar of the trailer.
